(19) United States
(12) Patent Application Publication
(10) Pub. No.: US 2024/0131934 A1
(43) Pub. Date: Apr. 25, 2024

(54) Control Method for an HV Contactor in a Battery Storage Device and Control Unit for the Implementation Thereof

(71) Applicant: ElringKlinger AG of Germany, Dettingen/Erms (DE)

(72) Inventor: Lars WELLER, Dettingen (DE)

(21) Appl. No.: 18/482,135

(22) Filed: Oct. 5, 2023

(30) Foreign Application Priority Data
Oct. 24, 2022 (DE) 102022128275.9

(51) Int. Cl. B60L 3/04; B60L 3/00; H01M 10/42; H01M 10/48; H01M 50/583; H02H 7/18

(52) U.S. Cl. CPC B60L 3/04; B60L 3/0046; H01M 10/425; H01M 10/48; H01M 50/583; H02H 7/18; H01M 2010/4271; H01M 2200/30; H01M 2220/20

(57) ABSTRACT

A control method for an HV contactor and a control unit for the implementation thereof in a battery storage device, preferably a battery storage device of an electric vehicle, wherein in the battery storage device, modules are interconnected via electromechanical components in the form of contactors, fuses, and busbars and are connected to a battery management system for controlling charging and discharging, wherein at least one respective contactor is provided for potential-free isolation at external electrical terminals. The control unit uses HV contactors installed bidirectionally in a positive and negative path of the high-voltage battery storage device to trigger an opening actuation of an HV contactor in order to interrupt a current flow only in a preferred direction of the respective contactor.

### FIELD OF THE INVENTION

The present invention relates to a control method for an HV contactor or relay in a battery storage device and to a control unit for the implementation thereof in a battery storage device, preferably a high-voltage battery storage device of an electric vehicle.

### DESCRIPTION OF THE PRIOR ART

In addition to stationary applications in which they serve as emergency power supplies and buffers for power peaks, large battery storage devices are now regularly also used in purely electric vehicles, i.e. as a substitute for propulsion by internal combustion engines. In addition to enclosed units in the form of battery cells and/or battery modules and elements for interconnecting these modules, these battery storage devices also contain a device for monitoring and controlling charging and discharging processes, which device is usually provided in a separate housing section or in a completely separate housing within the battery storage device and is often referred to as a high-voltage junction box or HVJB for short. Such a device is connected to components of the electronics, e.g. a battery management system BMS, temperature sensors, a current measuring shunt, fuses, busbars, and a precharging resistor, as well as electromechanical components, e.g. in the form of high-voltage contactors and precharging relays.

In an emergency, fuses ensure a voltage-free state for all poles on the high-voltage side or more specifically, the poles of the battery storage device. In a normal operation of the battery storage device, this task is performed by high-voltage switches, so-called HV contactors. There are two different variants of HV contactors: actuation and power supply via a so-called economizer or via a pulse-width modulated voltage or PWM. Both contactors with economizer actuation and contactors with PWM actuation normally have a preferred direction. This means that the contactors should always be controlled as a function of a current direction. There are also contactors without a preferred direction, but these are usually too large for automotive applications. Normally, contactors require voltage measurements upstream and downstream of the contactor to determine the prevailing status or switching state of the contactor as “open” or “closed”.

For HV contactors with PWM actuation that have AUX contacts, however, no additional voltage measurements upstream and downstream of the HV contactor are required. The prevailing switching state of the PWM contactor can be determined via the AUX contacts. PWM-controlled HV contactors are often less expensive than those with economizers and they also have the advantage of lower power consumption.

The preferred direction constitutes a challenge, particularly in HV contactors. The preferred direction must be taken into account when HV contactors are switched under load or more specifically, opened while current is flowing. When HV contactors are under current, it is only permissible for them to be switched in their preferred direction so that the absolute number of permitted or operationally reliable switching operations of a respective HV contactor can be achieved while retaining perfect functionality. The permitted load-free switching operations of an HV contactor are applicable only if the HV contactor is always switched in the preferred direction. For each HV contactor, there is also a number of switching operations in which it can open in the preferred direction with a very high current or can open counter to the preferred direction with a lower current. These values are applicable over the service life only if the contactor is always operated in the preferred direction.

In the event of an emergency or malfunction, an opening of at least one HV contactor in order to interrupt further current flow is preferable to a blowing of a fuse, particularly due to the reversibility of this process and also due to a typically faster response of an HV contactor compared to a fuse, regardless of temperature and aging.

The object of the present invention, therefore, is to create a control method for at least two HV contactors and a control unit for the implementation thereof in a high-voltage battery storage device, by means of which, in the specific case, in the event of an emergency or a malfunction, PWM high-voltage contactors with AUX contacts are actuated in such a way that a number of load cycles specified for the service life is achieved.

### SUMMARY OF THE INVENTION

According to the invention, this object is attained by means of a control method for an HV contactor in which, through the use of HV contactors installed bidirectionally in a positive and negative path of the high-voltage battery storage device, an actuation of an HV contactor for interrupting a current flow is carried out or occurs only when a flow direction of the current is oriented in a preferred direction of the relevant HV contactor.

This object is also attained by means of a control unit in which HV contactors are installed bidirectionally in a positive and negative path of the HV storage device and the control unit is embodied to trigger an opening actuation of a contactor as a current interruption of a current flow oriented only in a preferred direction of the relevant HV contactor. For the implementation, the two HV contactors are installed bidirectionally in the positive and negative paths of the HV storage device so that one of the HV contactors is always installed in the preferred direction for both charging and discharging.

In every high-voltage battery storage device, potential-free isolation in all poles is mandatory when the system is switched off. This potential-free isolation is usually brought about in a high-voltage junction box by the opening of HV contactors. In this connection, contactors are designed for a service life that is specified as a number of switching operations. But PWM-controlled HV contactors achieve this number of switching operations only if they interrupt a current flowing at a high voltage exclusively when the current is flowing in a preferred direction. If a current is flowing in the opposite direction from this preferred direction, then a considerable amount of wear on the HV contactor occurs so that maximum service life is far from achievable. If this is not monitored, then a sticking or welding of contactor contacts can occur, which means that it is no longer possible to ensure the isolation for all poles in cases of doubt.

The invention is thus essentially based on the realization that the cost advantages of PWM-controlled HV contactors can be utilized with a sufficient service life of this type of HV contactor if even in the event of an emergency or a malfunction, the switching of an HV contactor under current flow takes place only in the respective preferred direction. Since each battery storage device has two poles, each of which is to be switched to a potential-free state by an HV contactor, the HV contactors at the poles must therefore have preferred directions that are opposite from each other, wherein the HV contactors for interrupting a current flow are actuated by a control unit as a function of a respective current flow direction in such a way that an interruption of the current flow is produced by the HV contactor whose preferred direction is oriented in the prevailing flow direction of the current. Only thereafter, according to an advantageous modification of the invention, is a second HV contactor also opened by the control unit for a potential-free state for all poles. When the circuit is opened, all of the HV contactors whose preferred direction is oriented opposite from a flow direction of the prevailing current are therefore actuated only subsequently or more specifically in a currentless state and thus in a load-free state.

In a preferred embodiment of the invention, a control method is characterized in that a respective status of an HV contactor is read and monitored via the so-called AUX contacts. As a result, a welding or sticking of internal contacts of the HV contactor can be detected as a fault. Based on this, in the event of a welding or sticking of internal contacts of an HV contactor, a shake-loose procedure to unstick the internal contacts of the HV contactor is advantageously initiated, but only in a currentless state of the relevant HV contactor.

A control unit is advantageously embodied to store a respective preferred direction of each HV contactor and is also connected to a unit for determining a direction of current flow. From this combination of information, the control unit is able to reliably interrupt a current flow by opening a suitable HV contactor in every fault scenario.

In a modification of the invention, a current number of switching operations and a permissible number of switching operations for each of the HV contactors are stored in the control unit. An occurrence of wear in one of the HV contactors can be reliably detected when a number of permissible switching operations has been reached so that the control unit can promptly initiate a replacement as part of maintenance.

Finally, the control unit is advantageously connected to AUX contacts of the HV contactors and is embodied to detect a welding or sticking of internal contacts of any of the HV contactors. Based on this, the control unit is advantageously embodied to initiate and monitor a shaking loose of welded or stuck internal contacts of one of the HV contactors in a currentless state.

A control unit with one of the above-mentioned features is preferably positioned in and integrated into a battery management system BMS of the high-voltage battery storage device.

### BRIEF DESCRIPTION OF THE DRAWINGS

Additional features and advantages of embodiments according to the invention will be explained in greater detail below with reference to an exemplary embodiment based on the drawings. In the drawings:

FIG. 1: is a schematic circuit diagram of a battery storage device comprising a control unit and a plurality of electrical storage cells and

FIG. 2: is the schematic circuit diagram shown in FIG. 1 with graphically depicted current flows in a high-voltage operating state.

### DETAILED DESCRIPTION OF THE PREFERRED EMBODIMENTS

The same reference signs are used consistently for the same elements in the figures. Without limiting the field of application, the discussion below will focus on only one use of a device according to the invention in a pure electric vehicle, which is not itself described in greater detail. It is readily apparent to the person skilled in the art, however, that methods and devices according to the invention can also be used very advantageously in stationary energy storage devices, particularly in conjunction with wind power and/or photovoltaic systems.

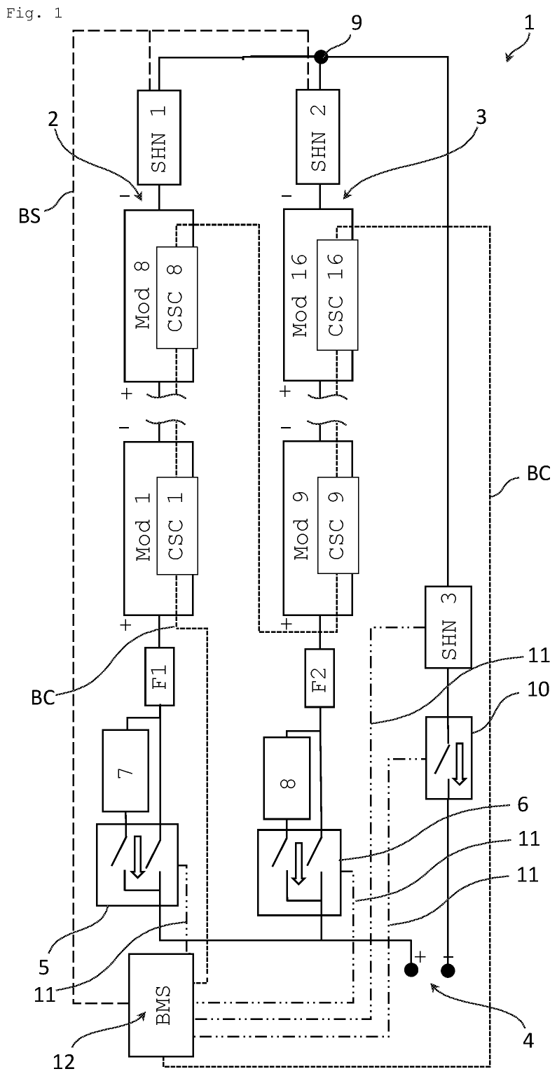

The sketch in FIG. 1 shows a circuit diagram of a battery storage device 1 with 16 modules Mod 1 to Mod 16, each of which comprises a plurality of elementary electrical storage cells that are not shown in detail. For each of these storage cells, a cell monitoring circuit CSC 1 . . . CSC 16 with sensors for a voltage and temperature measurement is provided in the respective module for electrical and thermal monitoring.

For the sake of clarity, only the modules Mod 1, Mod 8, Mod 9, and Mod 16 are shown as an abbreviated form representing the sixteen modules mentioned above, which are connected to form two sub-strings 2, 3. The first sub-string 2 comprises a series connection of modules Mod 1 to Mod 8 and the second sub-string 3 comprises a series connection of modules Mod 9 to Mod 16. The battery storage device 1 shown is in an idle state, i.e. external electrical terminals 4 with positive and negative polarity are isolated from the modules of both sub-strings 2, 3 by means of contactors 5, 6, 10.

The modules Mod 1, . . . , Mod 16 are interconnected to form two sub-strings 2, 3 with the same nominal voltage. The two sub-strings 2, 3 here are identically constructed as a series connection of eight modules Mod. A voltage of 400 V is present in both sub-strings 2, 3. They are each connected at an electrically positively charged end via a fuse F1, F2 to an HV contactor 5, 6 and are each connected to a precharging relay 7, 8. The person skilled in the art is aware that it would also be possible to hard-wire both strings in parallel and to use only one contactor with only one precharging relay on the positive side. At an electrically negatively charged end, the sub-strings 2, 3 are connected to a node 9 via current measuring resistors SHN1, SHN2. A negatively charged external terminal 4 of the battery storage device 1 is also connected to the node 9 via an HV contactor 10.

As a core feature of the present invention, the battery storage device 1 in this exemplary embodiment further comprises a battery management system BMS, which has been enhanced with a control unit 12, and is connected via a bus system BS to the current measuring resistors SHN1, SHN2, and via a separate bus system BC to the cell monitoring circuits CSC 1 . . . CSC 16 in the modules Mod 1 . . . Mod 16. The battery management system BMS also has control lines to the HV contactors 5, 6, 10 and to a detector for determining a direction of a current flow I in a current measuring resistor SHN3. These bus systems and control lines extending from the above-mentioned elements to the battery management system BMS are each depicted with dashed lines in the figures of the drawing.

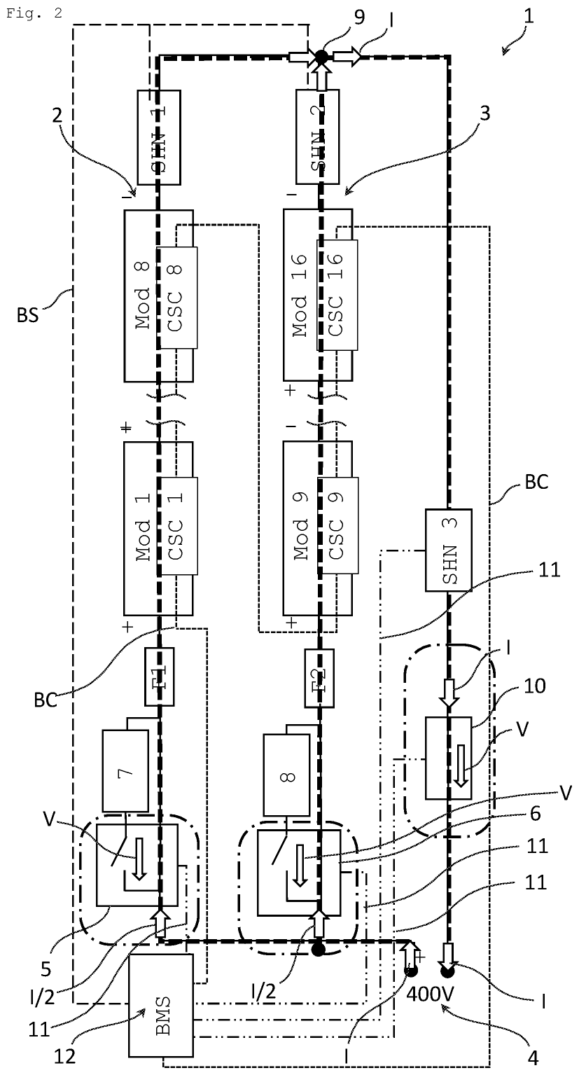

FIG. 2 shows the circuit diagram according to FIG. 1 in a high-voltage operating state. Partial currents through the two identical sub-strings 2, 3 add up to a total current I at node 9. With a voltage of 400 V at the external terminals 4, such a total current I reaches approx. 100 A or more. To protect the battery storage device 1 at the terminals 4, the contactors 5, 6, 10 must switch these terminals to a potential-free state in the event of an emergency.

The battery management system BMS of the HV battery storage device 1 is embodied to interrupt the flowing current I by opening the HV contactors 5, 6, 10 in the event of a fault or malfunction, in particular such as a short circuit, an overvoltage, or an undervoltage, and thus to prevent uncontrollable situations in and around the HV battery storage device 1. Also, in the event of an overcurrent, it must always be possible to reliably shut off the current flow I by opening the HV contactors 5, 6, 10. Since each HV contactor 5, 6, 10 can be operated reliably over only a predetermined number of switching cycles, the battery management system BMS is embodied to use the control unit 12 to track the service life of the HV contactors 5, 6, 10 by registering and storing the total number of opening/closing cycles of the HV contactors 5, 6, 10 separately for each of the HV contactors 5, 6, 10. The battery management system BMS thus knows a respective maximum number of cycles with which the HV contactors 5, 6, 10 can be opened and also uses an internal contactor counter to count how many more times the individual HV contactors 5, 6, 10 can still be opened during operation. This indicates a remaining lifespan until the replacement of a respective HV contactor 5, 6, 10. The maximum number of switching cycles of the HV contactor refers to load-free switching. Switching under load is taken into account here with a weighting factor that depends on the load that is present during the opening.

Under normal operating conditions, HV contactors functioning as electromechanical circuit breakers are opened only when the current flow is below a defined nominal value, e.g. below 5 A. If an HV contactor is opened under higher current loads, then this causes intensive aging of the affected HV contactor and it is no longer possible to achieve a specified number of switching operations. HV contactors actuated by pulse width modulated signals, also known as PWM, also have a preferred direction V and when they are under current, it is only permissible to switch them in this preferred direction so that it is possible to achieve the absolute number of permitted switching operations. In the event that a contactor is worn out, the closing of at least this HV contactor is prohibited or prevented by the control unit 12 within the battery management system BMS.

The preferred directions V of the respective HV contactors 5, 6, 10 are known to the control unit 12 within the battery management system BMS, wherein HV contactors 5, 6, 10 are installed bidirectionally in a positive and negative path of the HV battery storage device 1. Before an HV contactor 5, 6, 10 is opened when a current I is flowing, first a flow direction of a prevailing current flow I is checked by means of the unit 13. The control unit 12 therefore knows the HV contactors 5, 6, 10 for which the prevailing current I is flowing in the preferred direction V or counter to the preferred direction V. The HV contactors 5, 6, 10 are thus opened depending on a respective preferred direction V and a direction of a prevailing current flow I. When a current flow I is switched off or interrupted, the HV contactor with a preferred direction V oriented in the direction of the current I must be opened first and only then is a contactor with a preferred direction V counter to the current direction opened in order to avoid wear on the HV contactor with a preferred direction V oriented counter to the prevailing flow direction of the current I. Thus according to FIG. 2, the HV contactor 10 is opened first. Only then, when the interruption of the current flow has been completed, are the HV contactors whose preferred direction V was oriented counter to the flow direction of the current I also opened, i.e. HV contactors 5, 6 according to FIG. 2, in order to thus reliably produce a potential-free state for all poles at the contacts of the terminal 4 of the battery storage device 1.

An important point in the implementation of the method outlined above consists in the fact that the control unit 12 within the battery management system BMS detects welded HV contactors in order to prevent unreliable operation. For this purpose, a respective status of an HV contactor 5, 6, 10 is read and monitored via so-called AUX contacts. In this way, a welding of contacts of an HV contactor can also be detected via the AUX contacts. If a case occurs in which an HV contactor is stuck only at its internal switching contacts, then this HV contactor can be shaken loose. A shake-loose procedure is permissible only if the other HV contactor is open and the HV battery storage device 1 is therefore not connected via its contact 4 and more specifically, is currentless.

The present invention eliminates a major disadvantage in the use of PWM-controlled HV contactors in an HV battery storage device 1, which disadvantage, in the form of a preferred direction V, can sharply reduce an operationally reliable lifespan or service life of PWM-controlled HV contactors. By introducing a control unit 12 within the battery management system BMS, a preferred direction V of each HV contactor is now compared to a direction of a prevailing current flow or one that is planned by means of an activation. A switching of an HV contactor to interrupt the current is performed only when the preferred direction V and the current flow direction match and before a switching of the other HV contactors. When a current flow is being switched on, the reverse procedure is carried out. An HV contactor control for a PWM HV contactor is therefore always carried out taking into account its preferred direction and a current direction so that switching is only carried out in a preferred direction V under load or more specifically with current flow.

With the method described above, an HV contactor is switched counter to the preferred direction only if the HV contactor, which is installed in the preferred direction, is already open and the HV contactor can therefore be switched counter to the preferred direction in a load-free state. Otherwise, a switching counter to the preferred direction must be carried out even if the HV contactor through which current is flowing in the preferred direction is stuck during the opening process and can no longer be opened. In this case, an attempt is made to use the contactor to disconnect the circuit counter to the preferred direction in order to produce a safe state.

In this way, significantly improved operational reliability is achieved without increasing the overall volume, with low additional costs for components and materials, and with basic potential cost savings through the use of less expensive and more economical-to-operate HV contactors, as illustrated by the above-described exemplary embodiment.

1. A control method for an HV contactor in a high-voltage battery storage device, comprising:
using HV contactors that are installed bidirectionally in a positive and negative path of the high-voltage battery storage device, carrying out an opening actuation of an HV contactor in order to interrupt a current flow only in a preferred direction of the respective HV contactor.

2. The control method according to claim 1, wherein an opening actuation of an HV contactor in the case of an existing current flow counter to the preferred direction of the respective HV contactor is carried out only in a currentless state of the respective HV contactor.

3. The control method according to claim 1, wherein a respective status of an HV contactor is read and monitored via so-called AUX contacts in order to detect a welding or sticking of internal contacts of the HV contactor.

4. The control method according to claim 3, wherein in the case of a welding or sticking of internal contacts of the HV contactor, a shake-loose procedure to unstick the internal contacts of the HV contactor is initiated only in a currentless state.

5. A control unit for implementing the control method for HV contactors according to claim 1 in a high-voltage battery storage device, wherein in the high-voltage battery storage device, modules are interconnected via electromechanical components in the form of HV contactors, fuses, and busbars and are connected to a battery management system for controlling charging and discharging, wherein at least one respective HV contactor is provided for potential-free isolation at external electrical terminals, wherein
HV contactors are installed bidirectionally in a positive and negative path of the HV storage device and the control unit is embodied to trigger an opening or closing actuation of an HV contactor for interrupting or establishing a current flow only in a preferred direction of the respective HV contactor.

6. The control unit according to claim 5, wherein a respective preferred direction of each HV contactor is stored in the control unit and the control unit is connected to a unit for determining a direction of the current flow, wherein HV contactors are installed bidirectionally in a positive and negative path of the HV storage device.

7. The control unit according to claim 6, wherein a current number and a permissible number of switching operations for each of the HV contactors are stored in the control unit.

8. The control unit according to claim 5, wherein the control unit is connected to AUX contacts of the HV contactors and is embodied to detect a welding or sticking of internal contacts of any of the HV contactors.

9. The control unit according to claim 8, wherein the control unit is embodied to initiate and monitor a shaking loose of welded or stuck internal contacts of one of the HV contactors in a currentless state.

10. The control unit according to claim 5, wherein the control unit is positioned in and integrated into a battery management system of the high-voltage battery storage device.

11. The control method according to claim 1, wherein the high-voltage battery storage device is a high-voltage battery storage device of an electric vehicle.

12. The control unit according to claim 5, wherein the high-voltage battery storage device is a high-voltage battery storage device of an electric vehicle.
